(19) United States
(12) Patent Application Publication
(10) Pub. No.: US 2011/0107958 A1
(43) Pub. Date: May 12, 2011

(54) INPUT DEVICES AND METHODS OF OPERATION

(75) Inventors: Aleksandar Pance, Saratoga, CA (US); Michael Sinclair, Pembroke (BM); Brett Bilbrey, Sunnyvale, CA (US)

(73) Assignee: Apple Inc., Cupertino, CA (US)

(21) Appl. No.: 12/617,172

(22) Filed: Nov. 12, 2009

(51) Int. Cl. G09G 5/00; G01D 13/00

(52) U.S. Cl. 116/205; 345/156

(57) ABSTRACT

The disclosure describes input devices for processor-based systems, including computing systems, to provide enhanced user experience. The described systems provide tactile sensations providing feedback to a user. In some systems, feedback is provided before actual contact with the key expelling air from the input device proximate the key when user selection is imminent. In other examples, the tactile sensation results from automatic movement of the key in response to detected user selection of the key. Additional examples and variations are described herein.

### BACKGROUND

The present disclosure generally relates to input devices and methods of their operation, and more particularly, to input devices for computing systems, and methods operating such input devices, to provide tactile feedback to a user.

Many computing devices and other processor-based systems, such as computers, mobile communication devices, and portable media players, have become smaller and thinner (lower-profile) relative to prior counterpart devices. As a result, input devices associated with those devices, such as keyboards and key pads, have also become correspondingly smaller and lower-profile. These input devices may be lower profile out of necessity, for example to function as a part of a relatively low profile assembly (such as, for example, a relatively thin laptop computer or similar device), or may be low profile primarily for esthetic reasons.

In the cases of input devices such as keyboards and key pads, a relatively lower profile design dictates keys with relatively reduced travel relative to more conventionally sized devices. However, that reduced travel also changes, and typically limits, the tactile feedback experienced by a user. Thus, in many cases, such reduced travel input devices do not provide a fully satisfactory user experience for users accustomed to more conventional designs. In many cases, this less than fully satisfactory user experience includes less than satisfactory tactile feedback to the user, due to the limited travel of the keys.

### SUMMARY

Embodiments of input devices for processor-based systems, including computing systems, are described, as well as methods of operation of the input devices to provide enhanced user experience. Although applicable to all key or actuator-based input devices, the examples described herein are believed to offer particular advantages for low profile input devices, and also particularly to keyboards, key pads, and similar devices. In some examples, the user experience will be impacted by a change in the tactile feedback relative to conventional devices. One example of changed tactile feedback as described herein includes providing feedback to a user before actual contact with the key. That may be done by detecting the proximity of a user to a key of the input device that suggests an imminent user actuation of the key, and in response to detected proximity, to flow air from the input device proximate the key in question (such as, for example, through openings in a key surface, or through openings adjacent the key assembly), to provide tactile feedback to the user before physical contact with the key surface. In some cases, the air pressure may be applied in a manner to oppose motion of the user toward the key surface.

Other described embodiments include detecting user selection of a key and controlling movement of at least a contact surface of the selected key in response to the user selection. In one example, a pneumatic system will be used to advance the selected key in a direction of actuation in response to detecting user selection. The key is thus pneumatically pulled away from the user. In some examples, both of these described systems may be used in combination, providing initial air resistance to movement, and then withdrawing the key from the user's touch. Additional examples and variations will be described herein.

### BRIEF DESCRIPTION OF THE DRAWINGS

FIG. 1 depicts a low profile input device in association with a computing device in one common operating configuration.

FIG. 2 depicts a block diagram of an example input device for a computing system in accordance with an embodiment of the present invention.

FIG. 3 depicts a block diagram of the controller portion of the input device of FIG. 2.

FIG. 4A depicts a block diagram of a portion of an input device, such as the input device of FIG. 2.

FIG. 4B depicts a portion of the device of FIG. 4A, showing a top view of a key surface including a plurality of openings.

FIG. 4C depicts a proximity sensor suitable for use with the key assembly of FIG. 4A.

FIG. 5 depicts a flow diagram of an example method of operating the input device of FIG. 4A.

FIG. 6 depicts a block diagram an alternative embodiment of an input device, such as the input device of FIG. 2.

FIG. 7 depicts a flow diagram of an example method of operating the input device of FIG. 6.

FIG. 8 depicts a flow diagram of another example method of operating the input device of FIG. 6.

FIG. 9 depicts a representative key actuation profile illustrating one example pressure curve for key actuation of an input device.

FIG. 10 depicts a block diagram of another embodiment of a key assembly which incorporates functionality of the key assemblies of FIGS. 4A and 6.

FIG. 11 depicts a block diagram of one example of a computing system suitable for use with one- or more of the input devices as described herein.

### DETAILED DESCRIPTION

The following detailed description refers to the accompanying drawings that depict various details of examples selected to show how particular embodiments may be implemented and used. The discussion herein addresses various examples of the inventive subject matter at least partially in reference to these drawings and describes the depicted embodiments in sufficient detail to enable those skilled in the art to practice the invention. Many other embodiments may be utilized for practicing the inventive subject matter than the illustrative examples discussed herein, and many structural and operational changes in addition to the alternatives specifically discussed herein may be made without departing from the scope of the inventive subject matter.

For the purposes of this specification, a “processor-based system” or “processing system” includes a system using one or more processors, microcontrollers and/or digital signal processors having the capability of running a “program,” which is a set of executable machine code. A “program,” as used herein, includes user-level applications as well as system-directed applications or daemons. Processing systems include communication and electronic devices such as cell phones, music players, and Personal Digital Assistants (PDA); as well as computers, or “computing devices” of all forms (desktops, laptops, servers, palmtops, workstations, netbooks, tablets, etc.).

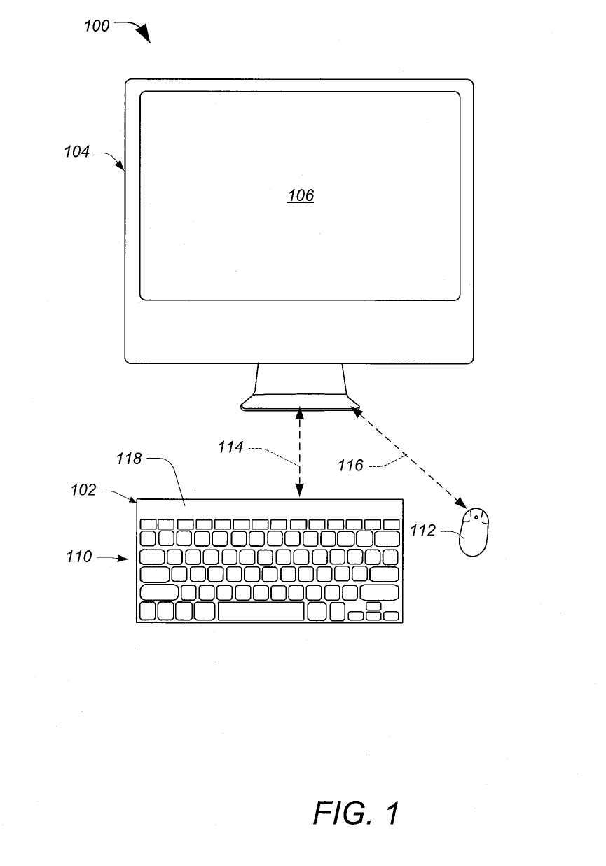

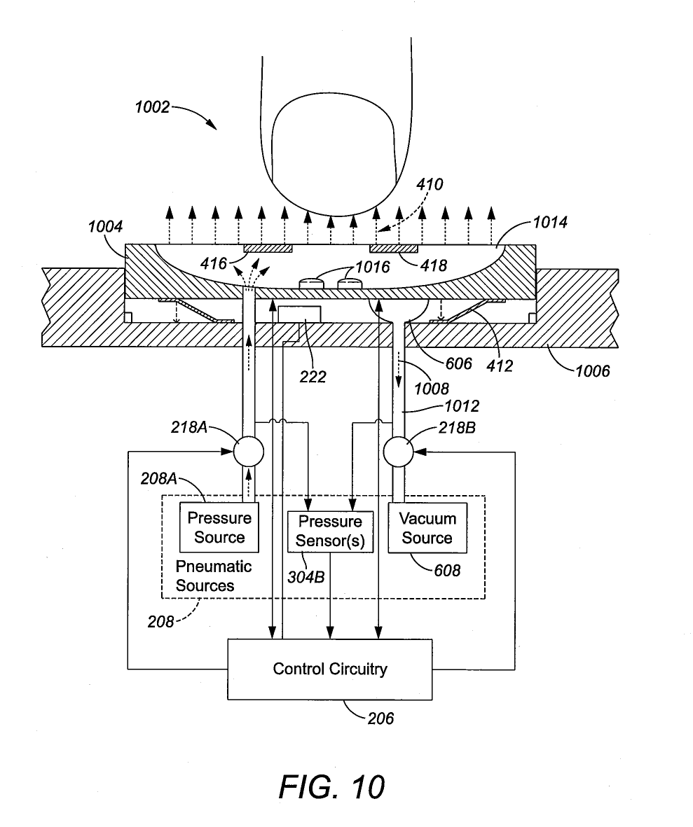

Referring now to FIG. 1, the figure depicts an input device in the example form of a keyboard 102 in association with a computing device 104 in one common operating environment, where keyboard 102 is a low-travel input device. Computing device 104 may be any of a plurality of conventional configurations, such as the example computing device described in more detail in reference to FIG. 10. Computing device 104 receives user inputs through keyboard 102 and mouse 112 through communications links 114 and 116, respectively. As known to those skilled in the art, communications links 114 and 116 may be either wired or wireless.

Keyboard 102 includes a housing 118 and a plurality of keys 110 supported by housing 118. Keys 110 may be selectively actuated by a user to provide alphanumeric and other inputs to computing system 104 through communications link 114. Each key of the plurality of keys 110 represents a selectable (movable) portion of a respective key assembly, supported by housing 118.

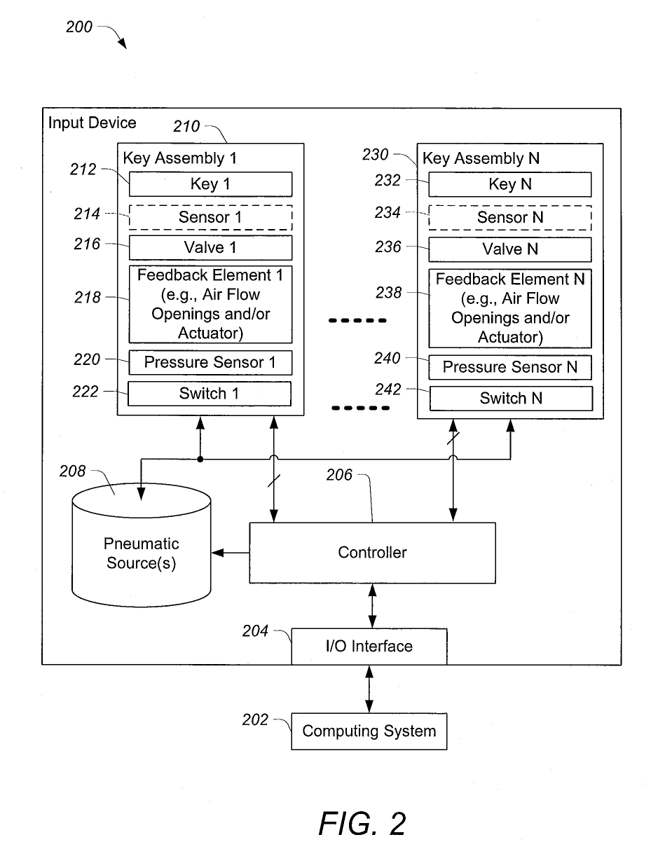

Referring now to FIG. 2, the figure a block diagram of an input device 200 as may be used in combination with a computing device 202. Input device 200 includes input/output (I/O) interface 204 communicatively coupled to computing device 202. I/O interface 204 is configured to communicatively couple, and in some instances physically couple, input device 200 to computing device 202. In one embodiment, I/O interface 204 includes a wireless transceiver to facilitate wireless communications. In another embodiment, I/O interface 204 includes a physical connector, such as a universal serial bus (“USB”) port or a cable with a connector configured to mate with a port of computing device 202.

Input device 200 further includes controller 206 coupled to I/O interface 204 and to a plurality of key assemblies, ranging from a first key assembly 210 to an N-th key assembly 230. Input device 200 can include any number of key assemblies as may be desired. Controller 206 is also coupled to one or more pneumatic sources 208, and the pneumatic source(s) are coupled to the key assemblies through one or more selectively-actuable fluid paths. The one or more pneumatic sources 208 may include a compressed air source (or pressure source), a vacuum source, or both, as will be addressed in more detail herein. Alternatively, the pneumatic source 208 will be an air pump, which may be controlled by controller 206 to either supply compressed air to a selected key assembly or withdraw air from the selected key assembly. Pneumatic sources will also include additional components conventionally used in pneumatic systems, including pressure accumulator, pressure sensors, relief valves, etc., as are well-known to those skilled with pneumatic systems.

Each key assembly 210, 230 includes a selectable key 212, 232, which a user will contact for a desired data input. In the example of input device 200, each key assembly 210, 230 includes a sensor 214, 234 to detect user proximity to the key and to communicate a signal indicating proximity to controller 206. Sensors 214 and 234 are depicted in phantom because they may be omitted in some embodiments.

Each key assembly 210, 230 also includes at least one valve assembly 216, 236, which will include a valve as well as appropriate conduits to selectively establish a path of fluid communication between one or more of the pneumatic sources 208 and the key assembly. Additionally, each key assembly 210, 230 includes at least one feedback element 218, 238. In one example, feedback element 218, 238 includes a plurality of air flow openings in a key surface of key 212, 232 through which air may be forced to provide direct pneumatic feedback to a user. In an alternative embodiment, feedback element 218, 238 includes an actuator to which air may be supplied or withdrawn to move the respective key and provide a pneumatically assisted key stroke. Additionally, in some examples, the actuator may be controlled to resist movement of the respective key. In some preferred examples, feedback element 218, 238 includes both air flow openings and an actuator, to provide both described forms of feedback to a user.

In the embodiments wherein air is expelled from the input devices, such as through apertures (preferably micro-perforations) in the keys, the objective is to provide a tactile user interaction even before contact with the key. For example, since the key travel will be relatively limited, air can be used to engage a user's finger even before contact with the key, to provide resistance to the user prior to actual contact. In these systems, the presence of a user can be detected at a proximity that is identifiable as likely indicating that physical actuation of the key is imminent, and that sensed proximity can be used to trigger the expelling of air proximate the key to provide a resistance sensation to the user.

In other embodiments, wherein pneumatic pressure is used to draw the key in an actuation direction—in effect, to draw the key away from the user's actuation motion, the effect is that once contact with the key surface is made, the motion of the key away from the actuation will provide a sensation suggesting to the user that a greater range of travel has occurred than has occurred in actuality.

In some examples, each key assembly 210, 230 will include a pressure sensor 220, 240 to monitor a pressure associated with the respective key assembly 210, 230 and to communicate data related to the pressure to controller 206. In many examples, the pressure will be measured in each valve assembly 216, 236 between the valve and the key. An increase in pressure indicates movement of the key, and thus user selection of the key.

Alternatively, other systems other systems may be used to detect user selection of an associated key 212, 232. In some examples, each key assembly includes a switch 222, 242 which mechanically detects movement of a key in the direction of actuation, indicating user selection of the key 212, 232, and provides the signal to controller 206. In other alternative embodiments, switches 222 and 242 can be omitted, and user selection and contact with a key 212, 232 may be determined using the previously-described proximity sensor 214, 234.

In operation, input device 200 detects a parameter (proximity or user selection) and provides tactile feedback to the user based on the parameter. In one example, the detected parameter is user proximity, which is detected by sensor 214, 234. In this embodiment, in response to detecting user proximity to key 212, controller 206 controls the valve in valve assembly 216 to couple pneumatic source 208 to feedback element 218 to force air through air flow openings in a key surface of the key 212 to provide direct pneumatic feedback to the user. When the user proximity exceeds a proximity threshold, controller 206 may modulate valve 216 to turn off the air flow, or may continue the air flow to resist movement of the key.

In other embodiments, the detected parameter is user contact (selection) of the key. When user selection of a key 212, 232 is detected, the selection is communicated to controller 206, which provides data related to the selection of that key to computing device 202 through I/O interface 204. In addition to providing data related to the user selection, controller 206 modulates the valve of valve assembly 216 to couple pneumatic source 208 to feedback element 218 to provide tactile feedback to the user through key 212 by moving key 212 in an actuation direction in response to either positive or negative pressure applied to the key assembly as a result of the operation of valve assembly 216. In an alternative example, controller 208 could control feedback element 218 to resist movement of key 212, for example by applying pneumatic pressure opposing movement of the key in the direction of actuation. In still another variation, controller 206 can control feedback element 218 to initially resist movement of key 212 and to then reduce resistance to movement of key 212.

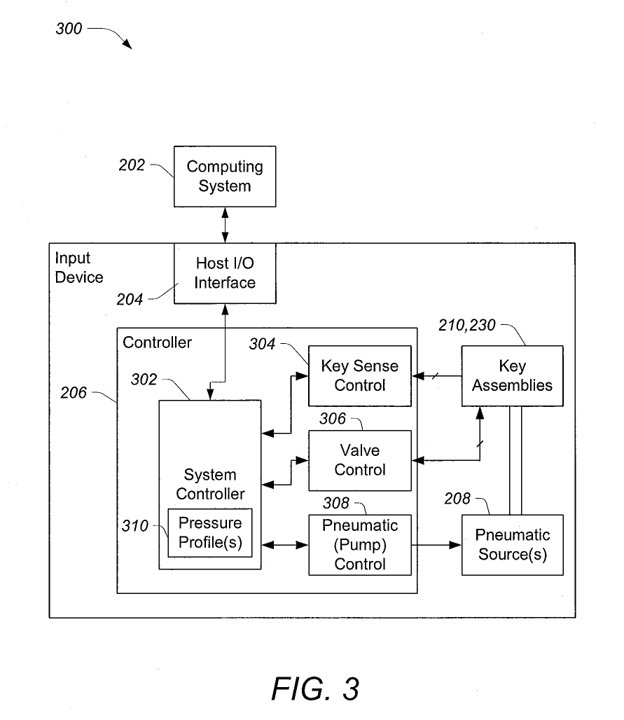

Referring now to FIG. 3, the figure depicts a block diagram of input device 200 of FIG. 2, illustrating controller 206 in greater detail. In the following discussion, elements of the Figures having substantially the same structure and function are identified with common reference numbers. Controller 206 includes system controller 302 coupled to key sense control 304, which receives signals from sensors within the key assemblies 210, 230, such as, e.g. sensor 214 and switch 222, and communicates the sensed data to system controller 302. As noted above, such sensed data may include one or more of user proximity, user contact/key selection, key movement/key selection, key assembly pressure, etc. When the sensed data includes key selection, system controller 302 communicates the selection to computing device 202 through host I/O interface 204 as user input data. Further, system controller 302 communicates with valve control 306 to modulate the valve associated with the selected key assembly to couple pneumatic source 208 to the feedback element associated with the selected key. System controller 302 also communicates with pneumatic control (or pump control) 308 to modulate pneumatic source 208 to provide positive or negative air pressure to the selected key assembly.

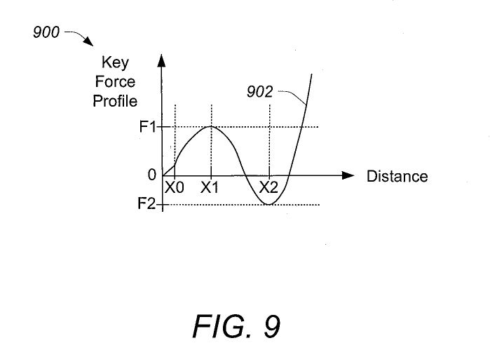

System control 302 can include one or more pre-determined pressure profiles 310, which may define one or more algorithms for modulating valves using valve control 306, for modulating pneumatic source 208 through pneumatic control 308, or for modulating both valves and pneumatic sources. Such algorithms may be configured to provide a desired force profile to simulate a tactile sensation of pressing a key. An example of a force profile that may be experienced by a user is depicted in FIG. 9A.

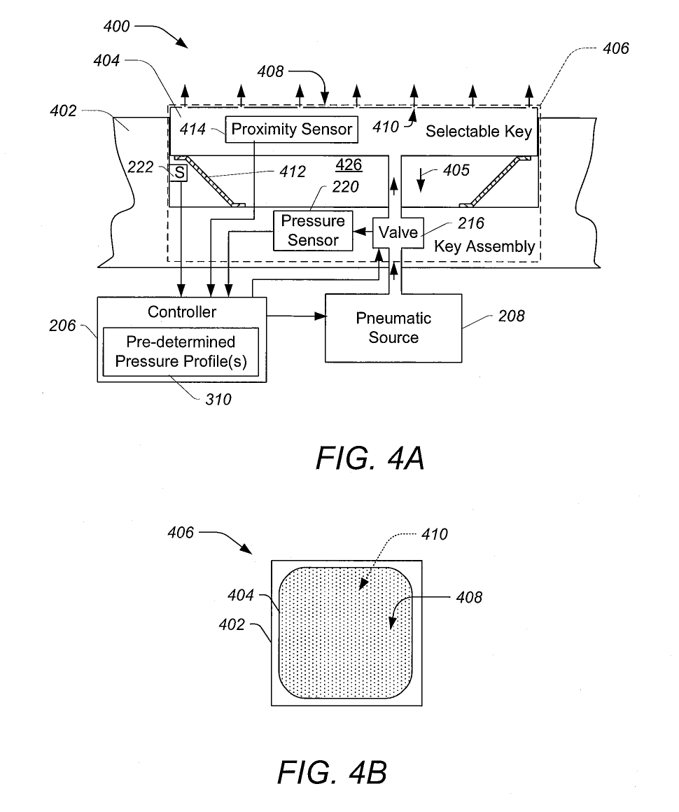

Referring now to FIG. 4A, the figure depicts a block diagram of a portion of an embodiment of input device 400, such as the input device 200 in FIG. 2, including a key assembly 406. Key assembly 406 is coupled to and supported by support member 402, which may be part of the housing 114 depicted in FIG. 1. Key assembly 406 includes selectable key 404, which may be moved in a direction of actuation, generally indicated by arrow 405. Key 404 includes a key contact surface 408 with a plurality of openings, indicted generally at 410, which communicate with a chamber 426 within key 404, and which represent an embodiment of feedback elements 216 and 236 depicted in FIG. 2. Each opening 410 may be a micro-perforation sized to permit air flow through key surface 408 while remaining relatively invisible to the naked eye. Each opening 410 can be a micro-perforation having a diameter that is less than a millimeter, and in some examples, each opening 410 will have a diameter of approximately 20-50 microns.

Key assembly 406 also includes proximity sensor 414, which represents an embodiment of sensor 214 in FIG. 2. Proximity sensor 414 detects user proximity to key 404 and communicates signals related to the proximity to controller 206. Key assembly 406 may also include switch 222 to detect movement of key 404. Switch 222 may communicate detected movement to controller 206, which transmits signals indicating user selection of key 404 to a computing system, such as computing device 202 depicted in FIG. 2. Again, in some embodiments, switch 222 may be omitted and user selection may be inferred based on user contact with key 404, which contact may be detected by proximity sensor 414.

Additionally, key assembly 406 includes a spring mechanism, here depicted as a mechanical spring 412 to secure key 404 in an at-rest position, to resist movement of key 404, and to restore key 404 to the at-rest position after user actuation. Spring 412 is a mechanical structure designed to apply an initial force to key 404 to resist movement of key 404 in the actuation direction 405. Here, spring 412 is an annular “dish” spring. As will be apparent to those skilled in the art, many other types of springs or resilient mechanisms may also be used, such as resilient foam members, pressurized bladders, etc.

In operation, proximity sensor 414 communicates a proximity signal to controller 206. As a user's finger approaches key 404, controller 206 will make a proximity determination, either by determining a distance between the user's finger and key 404, or more commonly by making a binary determination of proximity by comparing the proximity signal to a threshold or other reference. In response to the proximity determination, controller 206 will modulate at least one of valve assembly 216 and pneumatic source 208 to flow air through openings 410, providing direct pneumatic feedback to a user, as described above. For example, controller 206 may alter a duty cycle of a pulse-width-modulated (PWM) signal to control valve 216 and/or pneumatic source 208 to change an amount of air flow through openings 410.

FIG. 4B is a top view of key assembly 406 in the embodiment of FIG. 4A illustrating key surface 408 including a plurality of openings 410, depicted as micro-perforations. Other sizes of opening are also possible, so long as they permit air flow at an appropriate volume for the specific application. As an alternative to a generally uniform grid of micro-perforations as depicted, the micro-perforations might be provided in one or more selected patterns. With either embodiment, one or more light sources, (such as, e.g. LEDs (see FIG. 10)), may be included beneath the micro-perforations (as in chamber 426) to illuminate the key through the perforations. Illumination of the LEDs may be controlled by controller 206. Alternatively, such LEDs may be used in an optical proximity or contact system, to detect the presence of a user, as described herein.

FIG. 4C schematically depicts an example of a proximity sensor 414 that could be used with key assembly 406. Proximity sensor 414 includes electrodes 416 and 418, which are separated by a dielectric region (such as a plastic material of key 212, or merely an air gap between the electrodes). Electrodes 416 and 418 are coupled to controller 206, which controls power supplied to the electrodes 416 and monitors a capacitance (C) 422 between the electrodes.

User proximity to key 404 will alter a charge coupling (capacitance) 422 between electrodes 416 and 418. As shown, one or more capacitances 424 will form between electrodes 416 and 418 and the user, altering the charge coupling. Such alterations may be detected, for example, by key sense control 304 (depicted in FIG. 3) within controller 206. Further, variations in charge coupling may be monitored to track changes in user proximity relative to key 404. In particular, a charge coupling between electrodes 416 and 418 may decrease until the user contacts key 404, at which point the charge coupling stabilizes at a level that is different from the at-rest charge coupling when the user is not proximate key 404.

The arrangement of electrodes 416 and 418 represents only one of many configurations of capacitive sensors. In an alternative arrangement, electrodes 416 and 418 may arranged in a vertical arrangement, such that one of the electrodes is closer to a contact surface of key 404 than the other electrode, and the charge coupling may be affected by user proximity as previously discussed. Further, other types of proximity sensors 414 may be used. For example, sensor 414 may utilize an optical sensor, an infrared sensor to detect refraction of an infrared beam, or other types of sensors. While the proximity sensor has been described as being in the key, that configuration is not essential. The proximity sensor may be located in any other location that will provide the necessary sensing. Additionally, although the operable association of a separate proximity sensor with each key provides the greatest granularity of sensing to provide the most specific tactile feedback to a user, that configuration is not required, and a single proximity sensor might be operably with a number of key assemblies or contact locations.

The general functionality of the system of FIG. 4 may be implemented in other structural configurations than the depicted example. For example, the key assembly of the figure includes a key that is mechanically separate from, and moveable relative to, a supporting structure. However, the described flowing of air could also be implemented in a virtual keyboard, wherein each key location is merely a defined region on a solid surface, where contact with that surface region will generate a defined input signal. Such virtual keyboards may have no moveable surfaces. In such configurations, notwithstanding the absence of a moveable surface, the flowing of air through apertures in the surface may be used to provide a tactile resistance to a user's actuation motion and/or to absorb at least a portion of the actuation force. In another alternative configuration, the key assemblies might not be mechanically separate components as in FIG. 4, but may each include deformable regions. Such deformable regions may be formed of compressible materials (such as a gel or foam), by an air-filled (or other gas filled) pocket, or by a supported membrane; where in each case, actuation of an input is achieved by contacting the key assembly, and air may be expelled through or near the contact surface. In each case, the contact for actuation may be detected mechanically, electrically, pneumatically or optically.

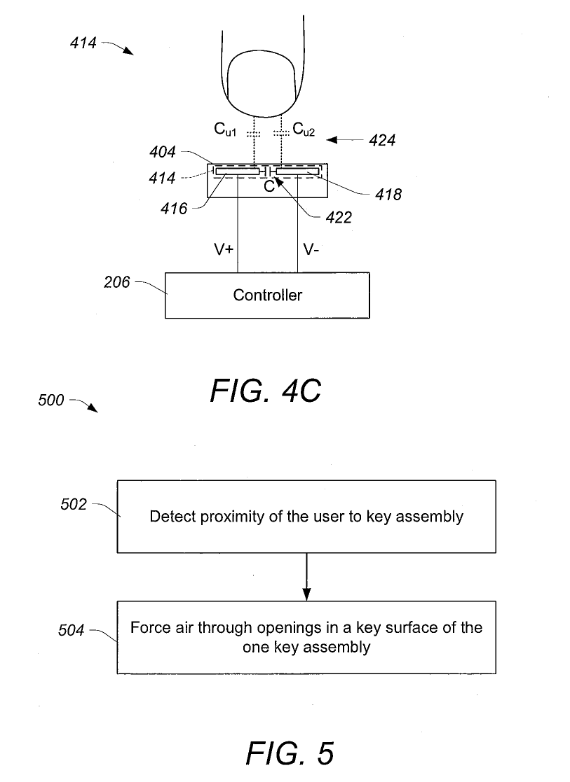

Referring now to FIG. 5, the figure depicts a flow diagram 500 of an embodiment of a method of operating the input device of FIG. 4A, which includes multiple key assemblies selectable by a user. At step 502, proximity of the user to one of the key assemblies is detected. Advancing to step 504, air is forced through openings in a key surface of a key of the one key assembly to provide a tactile sensation to the user, preferably even prior to physical contact with the key surface.

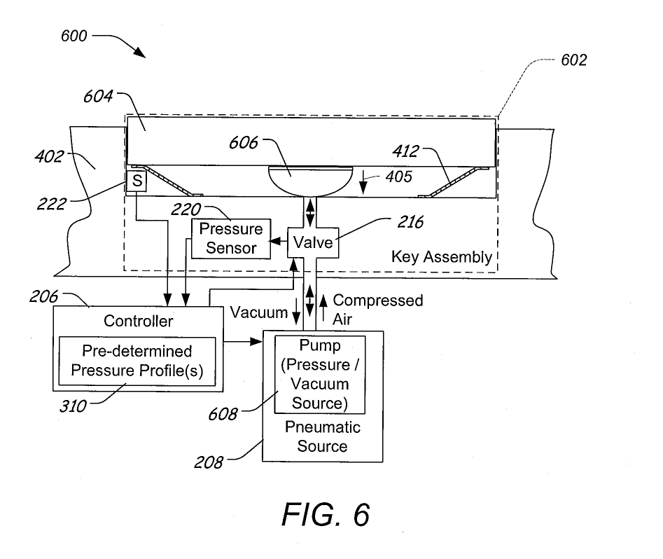

Referring now to FIG. 6, the figure depicts a block diagram of a portion of another embodiment of an input device 600. Input device 600 includes key assembly 602, including user selectable key 604 coupled to valve 216 through an actuator 606, in this example a bellows 606. Bellows 606 is sealed to key 604 and responsive to pneumatic source 208 through valve 216. A primary mode of operation for this configuration of key assembly is to automatically move the key in the actuation direction in response to an initial user contact. For this mode of operation, pneumatic source 208 may pump out the air or apply a pressure vacuum source using pump 608 to draw air from the actuator, causing the actuator to deflate and pull down (move) key 604 in the direction of actuation 605. Thus, the key is drawn away from the position of initial user contact, providing a distinct user feedback as compared to user pressing a key against a constant or increasing resistance. As an alternative, in another operational mode, for the key assembly, the actuator 606 may first be pressurized to resist movement of key 604, and then the pressure reduced either to allow key 604 to more easily move in a direction of actuation (generally indicated by arrow 605), or to affirmatively move key 604 in that direction.

While the system has been described in the context of applying a vacuum to draw the key in the actuation direction, it will be apparent to those skilled in the art that applying a vacuum, or lowered pressure to one side of a moveable piston is effectively equivalent to applying a positive pressure to the opposite side of the piston, and thus an application of air pressure, either raised or lowered, may be used to provide the desired force application to the key assembly. Alternatively, the key assembly may be of a configuration other than a piston. For example, as discussed earlier herein, the key assemblies may each be deformable, and thus may be configured to deform in response to internal air pressure (typically a negative air pressure), and to thereby draw the contact surface of the key assembly away from a user's actuation motion in a manner analogous to that described for the mechanical key assembly.

In the embodiment of input device 600, switch 222 detects movement of key 604, indicating user selection, and communicates the detected movement to controller 206. Controller 206 communicates the user selection to computing device 202. Further, controller 206 selectively activates valve 216 to couple pneumatic source 208 to key 604 to control movement of key 604 as described above.

The embodiment of input device 600 illustrates a single valve 216 to couple pneumatic source 208 (for example, a bi-directional pump 608) to supply positive or negative pressure to key assembly 602. In an alternative embodiment, pneumatic source 208 may include separate pressure sources, such as a positive pressure source and a negative pressure (vacuum) source. In this alternative embodiment, sources may be coupled to key assembly 602 through separate valves, such as separate instances of valve assemblies 216. Alternatively, valve 216 may be omitted and controller 206 can control air flow to the key assembly 602 by modulating the separate pressure sources independently, which may be coupled directly to the key assembly 602.

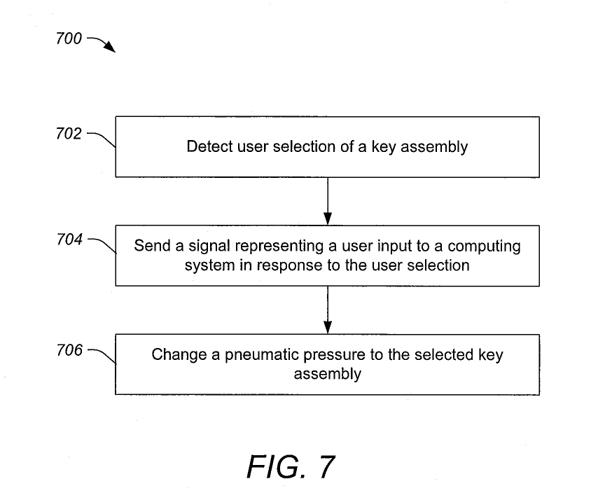

Referring now to FIG. 7, the figure depicts a flow diagram of an embodiment of a method 700 of operating input device 600 of FIG. 6. At 702, user selection of a key of an input device having multiple key assemblies is detected. As noted above, user selection can be determined in different ways, with actual contact with the key (and potentially also movement of the key) being useful for many applications. That contact or movement may be detected electrically, or pneumatically, as described earlier herein. Subsequently, a signal representing a user input is sent to the computing system in response to the user selection at 704. Subsequently, a pneumatic pressure to the selected key is changed at 706. This change in pneumatic pressure can be of various forms, as described above, ranging from discontinuing a positive application of pressure opposing movement in the direction of actuation to applying pressure (positive or negative) to a location in the key assembly to affirmatively move the key in the actuation direction. Additionally, more complex pressure management may be applied, for example, regulating pressure according to a pre-defined profile (such as the pressure profile depicted in FIG. 9A) to provide tactile feedback. The control of pressure in the desired manner may be achieved through many different control methods. For example, controller may modulate a duty cycle of a control signal to increase the pressure in an actuator until a certain deflection of the selected key is detected or until a pressure associated with the selected key exceeds a threshold. Thereafter controller may reduce the pressure to reduce resistance to movement of the key and/or to move the key. Finally, when the selected key reaches its full range of motion and contacts a stop location associated with the key assembly or support member, mechanical resistance to movement of the selected key is supplied by the support member.

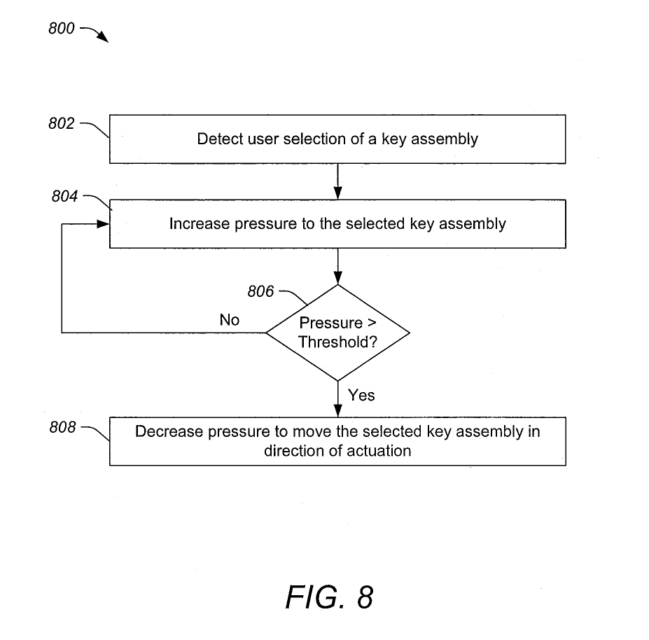

Referring now to FIG. 8, the figure depicts a flow diagram 800 of an alternative method of operating the input device of FIG. 6 wherein the pressure may be controlled to achieve a pressure profile, as described above. At 802, user selection of a key of a key assembly is detected. Pressure is increased to the selected key assembly in response to detecting user selection at 804. In some cases, this pressure may not be affirmatively increased, but rather the pressure will be allowed to increase as a function of the user's movement of the key. As indicated at 806, the system monitors a pressure within the selected key assembly. If the pressure does not exceed a threshold pressure, the method returns to step 804, and the pressure is increased to the selected key assembly. Otherwise, the method advances to step 808, and the pressure is decreased to move the selected key assembly in a direction of actuation. As noted above, this pressure decrease can be according to a predetermined profile, as depicted in FIG. 9.

FIG. 9 is a diagram of a representative key actuation profile 900 illustrating resistive force (represented by line 902) experienced by a user when a key is pressed. Line 902 increases from a point of zero deflection. At point X0, pressure applied by the user has moved the key an initial distance (X0), and switch 222 detects the user's selection. The initial linear increase in resistive force may be attributed to spring 412. As the key is advanced from X0 and X1, the resistive force is increased pneumatically from the spring force at X0 to F1 When the force reaches the level F1, the pressure is reduced according to this profile, reducing the resistive force from F1 to F2. As will be apparent, in reducing the pressure to F2, the curve goes below zero pressure (applying zero resistance to a user), and is affirmatively pulling the key away from the user's touch. This is believed to, in most instances, provide the user with the impression of a longer keystroke than is actually present. When the full range of the key's motion is reached at X2, the resistive force is supplied by the structure of the support member, and the key may not be advanced further without breaking the key or the support member.

Referring now to FIG. 10, the figure depicts an alternative configuration of a portion of an input device 1000 including a key assembly 1002 that incorporates functionality as previously described in reference to FIG. 4A and FIG. 6. Elements are constructed and function in essentially the same manner as elements discussed in reference to previously-discussed figures have been numbered the same as in those prior figures. Key assembly 1002 again includes a movable key 1004 retained within a recess within support member 1006. As will be apparent from the figure considered in view of the prior discussion herein, key assembly 1002 provides both the functionality of expelling air through a contact surface of key 1004 and the assisted movement of the key in the direction of actuation 1008. As this functionality has been described in some detail, the basic operation of the depicted key assembly will not be addressed in detail. A structural difference in key assembly 102 is that both an inlet conduit 1010 and an outlet conduit 1012 are provided, each with a respective valve 218A and 218B. Thus, valve 218A controls the flow of pressurized air from pressure source 208A into chamber 1014 to be expelled through micro-perforations or other apertures 410, and valve 218B controls the withdrawing of air from bellows 606 by a vacuum pressure source 608. As identified earlier herein, a pair of LED's 1016 are depicted, which may be used either for illumination through openings 410 or for optical sensing of proximity or contact.

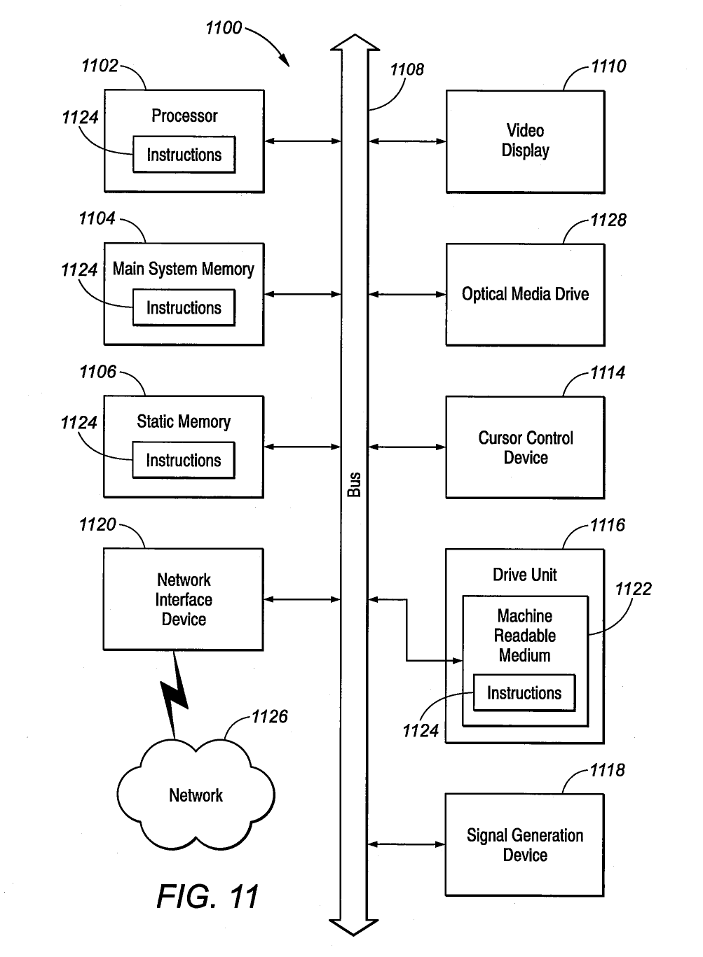

Referring now to FIG. 11, the figure depicts a simplified block diagram of a machine in the example form of a processing system, such as a computing device, with which the input devices described herein may be used. In this type of computing device, a set of instructions will be provided, and will preferably be stored, for causing the machine to perform any one or more of the methodologies discussed herein, may be executed. In alternative embodiments, the machine may be connected (e.g., networked) to other machines. In a networked deployment, the machine may operate in the capacity of a server or a client machine in client-server network environment, or as a peer machine in a peer-to-peer (or distributed) network environment. While only a single machine is illustrated, the term “machine” shall also be taken to include any collection of machines that individually or jointly execute a set (or multiple sets) of instructions to perform any one or more of the methodologies discussed herein.

Example computing device 1100 includes processor 1102 (e.g., a central processing unit (CPU), a graphics processing unit (GPU) or both), main system memory 1104 and static memory 1106, which communicate with each other via bus 1108. Computing device 200 may further include video display unit 1110 (e.g., a plasma display, a Liquid Crystal Display (LCD), Organic Light Emitting Diode (OLED) display, Thin Film Transistor (TFT) display, or a cathode ray tube (CRT)). Computing device 1100 also includes optical media drive 104, user interface (UI) navigation device 1114 all (e.g., a mouse), disk drive unit 1116, signal generation device 1118 (e.g., a speaker), optical media drive 1128, and network interface device 1120.

Disk drive unit 1116 includes machine-readable medium 1122 on which is stored one or more sets of instructions and data structures (e.g., software 1124) embodying or utilized by any one or more of the methodologies or functions described herein. Software 1124 may also reside, completely or at least partially, within main system memory 1104 and/or within processor 1102 during execution thereof by computing device 200, with main system memory 1104 and processor 1102 also constituting machine-readable, tangible media. Software 1124 may further be transmitted or received over network 1126 via network interface device 1120 utilizing any one of a number of well-known transfer protocols (e.g., Hypertext Transfer Protocol (HTTP)).

While machine-readable medium 1122 is shown in an example embodiment to be a single medium, the term “machine-readable medium” should be taken to include a single medium or multiple media (e.g., a centralized or distributed database, and/or associated caches) that store the one or more sets of instructions. The term “machine-readable medium” shall also be taken to include any medium that is capable of storing or encoding a set of instructions for execution by the machine and that cause the machine to perform any one or more of the methodologies of the present application, or that is capable of storing, or encoding data structures utilized by or associated with such a set of instructions. The term “machine-readable medium” shall accordingly be taken to include, but not be limited to, solid-state memories, optical and magnetic media, and other structures facilitating reading of data stored or otherwise retained thereon.

In the present description, references to “one embodiment” or “an embodiment,” or to “one example” or “an example” mean that the feature being referred to is, or may be, included in at least one embodiment or example of the invention. Separate references to “an embodiment” or “one embodiment” or to “one example” or “an example” in this description are not intended to necessarily refer to the same embodiment or example. However, neither are such embodiments mutually exclusive, unless so stated or as will be readily apparent to those of ordinary skill in the art having the benefit of this disclosure. Thus, the inventive subject matter may include a variety of combinations and/or integrations of the embodiments and examples described herein, as well as further embodiments and examples as defined within the scope of all claims based on this disclosure, as well as all legal equivalents of such claims.

Many additional modifications and variations may be made in the techniques and structures described and illustrated herein without departing from the spirit and scope of the present invention. For example, instead of initially providing air flow to the key, the valve may be closed to prevent air flow from the key. Accordingly, the present invention should be clearly understood to be limited only by the scope of the claims and the equivalents thereof.

We claim:

1. An input device for a computing system, the input device comprising:
a pneumatic source of pressurized air;
a plurality of key assemblies, each key assembly in that plurality including,
a key having a contact surface;
a proximity sensor configured to detect a user approaching the key contact surface; and
a valve assembly in fluid communication with the pneumatic source and the chamber, and configured to selectively couple the pneumatic source to the chamber; and
a controller configured to control the valve assemblies of each of the key assemblies, and to control a respective valve in response to detecting the user approaching the contact surface of the key associated with that valve to expel air from the input device proximate that key.

2. The input device of claim 1, wherein each key assembly further comprises:
a pressure sensor coupled to the valve to measure a pressure parameter; and
wherein the controller is configured to selectively control the valve at least partially in response based on the pressure parameter.

3. The input device of claim 1, wherein the proximity sensor comprises a capacitive sensor configured to sense the proximity of the user to the associated key contact surface.

4. The input device of claim 1, wherein:
each key further comprises a plurality of surfaces defining a chamber in fluid communication with the contact surface;
wherein each key comprises a plurality of openings in the key contact surface; and
wherein the air will be expelled through the openings.

5. An input device for a computing system, the input device comprising:
a first pneumatic source of negative air pressure;
a plurality of key assemblies including, with each key in that plurality including,
a key having a contact surface;
an actuation sensor configured to detect user actuation of the key,
an actuator operatively coupled to the key; and
a first valve assembly in fluid communication with the pneumatic source and the actuator, and configured to selectively couple the pneumatic source to the actuator; and
a controller configured to control the valve assemblies of each of the key assemblies, and to control a respective valve in response to a detected user actuation of a key associated with that valve to couple the pneumatic source to the actuator.

6. The input device of claim 5, wherein each key assembly further comprises:
a pressure sensor coupled to the valve assembly to measure a pressure parameter; and
wherein the controller is configured to selectively control the valve assembly at least partially in response to the measured pressure parameter.

7. The input device of claim 5, wherein the actuation sensor is configured to sense physical movement of the key.

8. The input device of claim 5, wherein each actuator comprises a deformable bellows coupled to a surface of the respective key, the bellows configured to reduce in size in response to negative air pressure within the bellows.

9. The input device of claim 5, further comprising:
a second pressure source, the second pressure source configured to supply air at a positive pressure; and
wherein each key assembly further comprises,
a fluid distribution chamber;
a proximity sensor configured to detect a user approaching the key contact surface
a second valve assembly in fluid communication with the second pneumatic source and the actuator, and configured to selectively couple the second pneumatic source to the fluid distribution chamber; and
wherein the controller is further configured to control a respective valve of the second valve assembly in response to detecting the user proximity to the contact surface of the key associated with that valve.

10. A method of operating a processor system input device including multiple key assemblies selectable by a user, comprising the acts of
detecting proximity of the user to one of the key assemblies; and
in response to detecting proximity or a user, expelling air from the input device proximate the one key assembly.

11. The method of claim 10, wherein the act of detecting proximity of the user comprises detecting a change in capacitance between electrodes of a capacitor associated with the one key assembly.

12. An input device for a processing system, comprising:
a support member;
a plurality of flow key assemblies supported by the support member, each key assembly comprising a key and a sensor;
at least one pneumatic source;
a plurality of individually-actuable valve assemblies in fluid communication with the pneumatic source, each valve assembly controllable to establish fluid communication between the pneumatic source and a respective key assembly;
a controller configured to control each valve assembly in response to a signal from the sensor of the key assembly operably associated with that valve.

13. The input device of claim 12, wherein the sensor is a proximity sensor; wherein the pneumatic source is a source of positive pressure; and wherein operation of a valve assembly will cause the flow of the air from the input device at a location proximate that valve assembly.

14. The input device of claim 12, wherein the sensor is configured to detect user selection of a key of a key assembly; and wherein operation of a valve assembly will cause fluid communication between the pneumatic source and the key assembly, and will result in movement of the key in an actuation direction.

15. The input device of claim 14, wherein the sensor is a pressure sensor configured to detect user selection of a key of a key assembly through a change in pressure within the valve assembly.

16. The input device of claim 14, wherein the sensor is a mechanical sensor configured to detect user selection of a key of a key assembly through movement of the key.

17. The input device of claim 14, wherein the sensor is an optical sensor, configured to detect user selection of a key through an optical measurement.

18. An input device for a computing system, the input device comprising:
a pneumatic source of air pressure;
a sensor assembly including at least one of a proximity sensor and a contact sensor;
at least one key assembly, including,
a contact surface;
a chamber;
a selectively-actuable fluid path between the pneumatic source and the chamber, configured to selectively couple the pneumatic source to the chamber; and
a controller coupled to the sensor assembly, and configured to actuate the selectively-actuable fluid path, and to selectively couple the pneumatic source to the chamber in response to the sensor assembly.

19. The input device of claim 18, wherein the pneumatic source is a source of negative air pressure, wherein the contact surface is movable in an actuation direction, and wherein actuation of the selectively-actuable fluid path moves the key assembly contact surface in the actuation direction.

20. The input device of claim 18, wherein the pneumatic source is a source of positive air pressure, and wherein actuation of the selectively-actuable fluid path expels air from the input device proximate the key assembly.

21. The input device of claim 18, wherein the device comprises a plurality of key assemblies and a plurality of proximity sensors, wherein the number of proximity sensors is less than the number of key assemblies.

22. The input device of claim 19, wherein the contact surface is a portion of a key mechanically coupled to a supporting structure in the input device.

23. An input device for a computing system, the input device comprising:
a pneumatic source of air pressure;
at least one sensor assembly;
a plurality of contact locations having apertures proximate thereto;
a plurality of selectively-actuable fluid paths between the pneumatic source and the contact locations, each configured to selectively couple the pneumatic source to apertures proximate at least one contact location; and
a controller coupled to the sensor assembly, and configured to actuate a selectively-actuable fluid path to selectively couple the pneumatic source to the apertures proximate at least one contact location in response to the sensor assembly.

24. The input device of claim 23, wherein the contact locations are not moveable relative to the remainder of the input device.

25. The input device of claim 23, wherein the contact locations are moveable relative to the remainder of the input device in response to an actuation contact from a user.
